(19) United States
(12) Patent Application Publication
(10) Pub. No.: US 2024/0394564 A1
(43) Pub. Date: Nov. 28, 2024

(54) EXPLORATORY OFFLINE GENERATIVE ONLINE MACHINE LEARNING

(71) Applicant: Fujitsu Limited, Kawasaki-shi (JP)

(72) Inventors: Wei-Peng CHEN, Fremont, CA (US); Sou HASEGAWA, Sunnyvale, CA (US); Mehdi BAHRAMI, San Jose, CA (US); Lei LIU, San Jose, CA (US)

(73) Assignee: Fujitsu Limited, Kawasaki-shi (JP)

(21) Appl. No.: 18/324,115

(22) Filed: May 25, 2023

(51) Int. Cl. G06N 5/022

(52) U.S. Cl. CPC G06N 5/022

(57) ABSTRACT

A method may include obtaining a set of preliminary tabular datasets and tasks to be performed by preliminary machine-learning (ML) pipelines. The method may further include training a meta-model that predicts performance of ML pipelines in performing the tasks using the preliminary ML pipelines, the preliminary ML pipelines synthesized as different approaches for performing the tasks. The method may also include obtaining a candidate tabular dataset and predicting, using the meta-model, performance of a plurality of candidate ML pipelines for performing the tasks on the candidate tabular dataset. The method may also include selecting a threshold number of top-performing candidates of the plurality of candidate ML pipelines as predicted by the meta-model for training to perform the tasks. In addition, the method may include identifying a top-performing ML pipeline based on performance of the trained top-performing candidates.

### FIELD

The embodiments discussed in the present disclosure are generally related to exploratory offline generative online machine learning.

### BACKGROUND

Machine learning (ML) generally employs ML models that are trained with training data to make predictions that become more accurate with ongoing training. ML may be used in a wide variety of applications including, but not limited to, traffic prediction, web searching, online fraud detection, medical diagnosis, speech recognition, email filtering, image recognition, virtual personal assistants, and automatic translation.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an example embodiment, a method may include obtaining a set of preliminary tabular datasets and tasks to be performed by preliminary machine-learning (ML) pipelines. The method may further include training a meta-model that predicts performance of ML pipelines in performing the tasks using the preliminary ML pipelines, the preliminary ML pipelines synthesized as different approaches for performing the tasks. The method may also include obtaining a candidate tabular dataset and predicting, using the meta-model, performance of a plurality of candidate ML pipelines for performing the tasks on the candidate tabular dataset. The method may also include selecting a threshold number of top-performing candidates of the plurality of candidate ML pipelines as predicted by the meta-model for training to perform the tasks. In addition, the method may include identifying a top-performing ML pipeline based on performance of the trained top-performing candidates.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a diagram representing an example system related to automatically generating new machine learning pipeline based on a dataset;

FIG. 2 illustrates an example diagram that includes a set of operations that may be performed to generate new machine learning pipelines and determine top-performing pipelines;

FIG. 3 illustrates an example flowchart of an example method of training a ML model and predicting top-performing pipelines;

FIG. 4 illustrates an example flowchart of an example method of training a meta-model;

FIG. 5 illustrates an example illustrates an example flowchart of an example method of generating meta-features during a generative online phase;

FIG. 6 illustrates an example flowchart of an example method of removing one or more options for preprocessing components and generating candidate ML pipelines;

FIG. 7 illustrates an example flowchart of an example method of training a failure model to predict and remove pipelines with high probability of failure;

FIG. 8 illustrates an example system related to automatically generating new machine learning pipeline based on a dataset; and

FIG. 9 illustrates an example computing system that may be used for automated exploratory offline generative online machine learning model.

### DESCRIPTION OF EMBODIMENTS

Some embodiments described in the present disclosure relate to methods and systems of automatically training a machine learning (ML) model based on ML pipelines and determining top-performing pipelines for a given dataset based on the ML model. As used herein, a ML pipeline may refer to a series of operations and/or systems that may facilitate performance of a task using one or more ML models, such as one or more pre-or post-processing operations performed on a dataset, the feeding of the dataset to the one or more ML models, and an output of the one or more ML models, ultimately performing the task.

By way of example, an exploratory off-line mode may be used in which a system may generate a large number of preliminary pipelines and explore their effectiveness in performing one or more tasks using test datasets. In doing so, a meta-model may be trained based on the performance of the preliminary pipelines. For example, the meta-model may take as inputs meta-features of (e.g., characteristics of) the datasets and/or meta-features of (e.g., characteristics of) the preliminary pipelines such that the meta-model is able to predict performance of a given ML pipeline for performing a given task on a given dataset based on the meta-features of the given dataset and the meta-features of the given ML pipeline.

After training the meta-model, in an on-line or real-time mode, the system may receive a candidate dataset and generate candidate pipelines for performing a given task. The trained meta-model may identify a threshold or target number of the candidate pipelines that would be expected to perform well at the given task based on the meta-features of the candidate dataset and/or the meta-features of the candidate pipelines. In some embodiments, the threshold or target number may specify a fixed number of the candidate pipelines to be selected. In these and other embodiments, the threshold or target number may be determined based on a time budget. For instance, the threshold or target number may increase with higher time budget and decrease with lower time budget. The threshold or target number of top performing candidate pipelines may be trained using the candidate dataset and a single, apex top-performing pipeline from that set may be determined. Additionally, as such processes can be performed independently for different pipelines, multiple candidate pipelines can be handled on different computing resources at the same time.

By using such an approach, machine learning models associated with tabular data may be improved. For example, the meta-model may be trained to be more accurate in its predictions due to the large number of the preliminary pipelines used in training that is available because of the off-line exploratory phase. During the off-line mode, more time or more computing resources may be spent searching for and generating pipelines that may be more suitable or less suitable for the datasets such that the meta-model has a broader diversity of pipelines on which to base its prediction. In some circumstances, generating the pipelines and training the meta-model during the off-line mode may improve operations of a computer because the exploratory off-line operations may be performed in non-peak times, which may conserve computing resources and/or electrical power for times when computing resources are more limited. The present approach may also improve the use of tabular data in machine learning. Machine learning generally performs better with unstructured data such as image or text data because a wide range of known representations and pre-trained models may be available. However, unlike image or text data, there is no well-known representation and/or pre-trained models for tabular data. Some issues that may cause this lack of well-known representations and/or pre-trained models may be challenges associated with the tabular data such as lack of locality, data sparsity, mixed feature types, and/or lack of knowledge of dataset structure. The present disclosure may provide a method of extracting meta-features from the tabular dataset for the machine learning to be more applicable and better able to operate on tabular datasets.

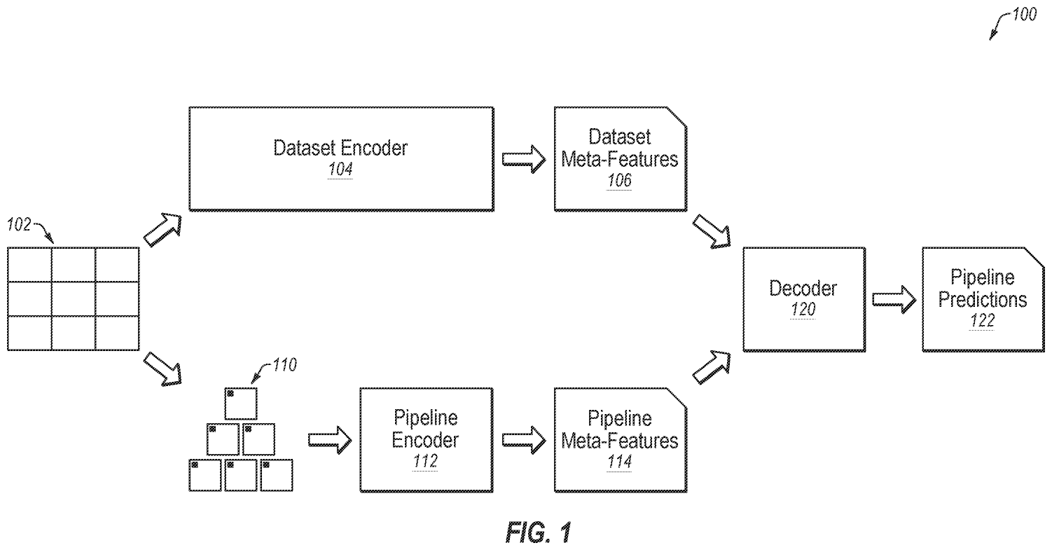

FIG. 1 illustrates a diagram representing an example system 100 related to automatically generating new machine learning (ML) pipelines based on a dataset, arranged in accordance with at least one embodiment described in the present disclosure. The system 100 may include a dataset encoder 104, a pipeline encoder 112, and a decoder 120. The dataset encoder 104 may be configured to derive dataset meta-features 106 based at least on a dataset 102. In some embodiments, the pipeline encoder 112 may be configured to derive pipeline meta-features 114 from ML pipelines 110. In some embodiments, the decoder 120 may be configured to predict performance of the ML pipelines 110 when performing a designated task or set of tasks on the dataset 102. The prediction of the decoder 120 may be based on the dataset meta-features 106 and/or the pipeline meta-features 114.

In some embodiments, the system 100 may be used in different phases of an exploratory offline generative online machine learning model of the present disclosure. For example, the system 100 may be used during an exploratory offline phase. The exploratory offline phase may be a phase to synthesize preliminary pipelines through exploring different combinations of preprocessing and ML model options and evaluating performances of the synthesized preliminary pipelines. In some embodiments, more time may be spent during the exploratory offline phase to explore and synthesize efficient pipelines. In these and other embodiments, the decoder 120 may include an ML model trained during the exploratory offline phase to predict the performance of various ML pipelines based on observations made during the offline exploratory phase.

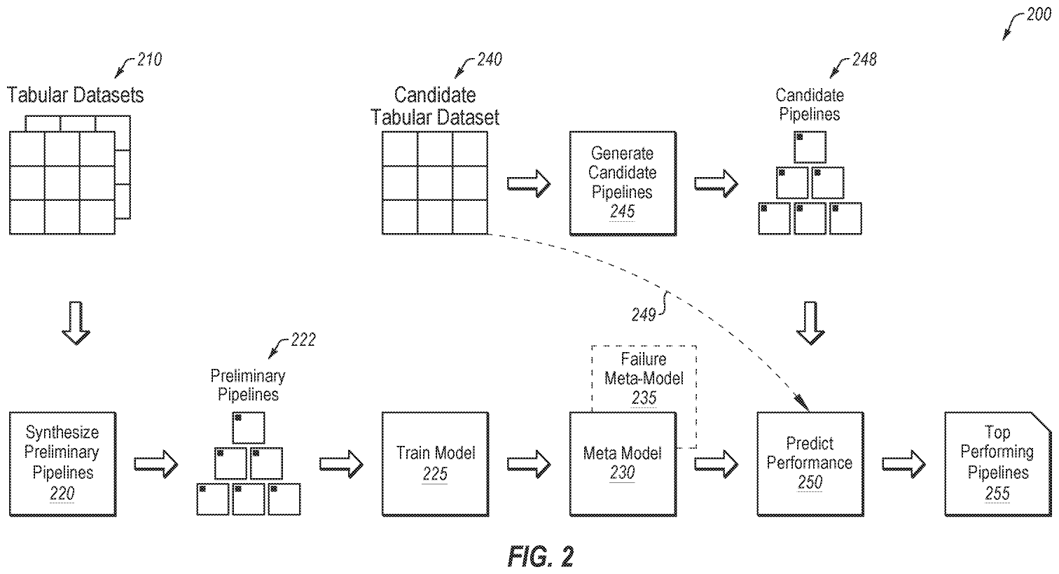

In some embodiments, the system 100 may be used during a generative online phase to generate candidate pipelines that may be used on an input data, and the decoder 120 may be used to predict how the candidate pipelines are predicted to perform on the input data. Various aspects of how the system 100 may be used with different phases may be illustrated and explained in greater detail with reference to FIG. 2.

The dataset 102 may include electronic data. The electronic data may include any suitable type of data to be analyzed. In some embodiments, the dataset 102 may be represented or stored as a set of tabular data. In some embodiments, the dataset 102 may be stored in one or more databases. For example, the electronic data included in the dataset 102 may be stored in columns and rows. In some instances, the columns may represent categories of information. For example, each column may include a different category of information. In these and other embodiments, the rows may represent an instance of data. For example, each row may include a single data entry that may be characterized by corresponding values in the categories of information represented by the columns. In some embodiments, the dataset 102 may include a description or definition of one or more ML task(s) which may indicate a type of ML operation to be performed for the data in the dataset 102. In some embodiments, the ML task may include one or more suitable ML operations that may be performed on the dataset 102. For example, the ML task may include a classification. In another example, the ML task may include a regression. The ML pipelines 110 may include one or more pipelines that may be used to process the dataset 102 e.g., to perform a task identified in the dataset 102. Each ML pipeline may include one or more sequential steps that may codify and automate workflow to produce a machine learning model. For example, each ML pipeline may include a sequence of ML operators that processes the dataset 102 to make it suitable for learning, fits a suitable ML model on the data, and calculates the performance of the model. In some embodiments, the one or more sequential steps may be represented as functional blocks, with each functional block corresponding to a particular type of functionality.

In some embodiments, the ML pipelines 110 may be generated based on the dataset 102 and one or more existing ML projects. For example, the one or more existing ML projects may include one or more existing ML pipelines. One or more functional blocks may be extracted from the one or more existing ML pipelines to generate the ML pipelines 110. The generation of the ML pipelines 110 may be described in further detail with reference to FIG. 2 of the present disclosure.

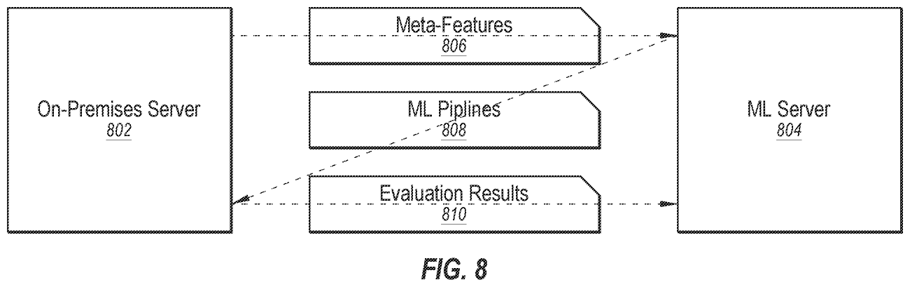

In some embodiments, the dataset 102 may include public data. For example, the dataset 102 may be derived from the one or more existing ML projects. For instance, the dataset 102 may include the public data used in the one or more existing ML projects. Additionally or alternatively, the dataset 102 may include private data. For example, the private data may include confidential datasets owned by customers. In these and other embodiments, a part of the system 100 may be located at on-premises servers of the customers. For example, the on-premises servers may enhance confidentiality of the confidential data included as part of the dataset 102. An example of on-premises servers hosting part of the system 100 may be described in further detail with reference to FIG. 8.

The dataset encoder 104 may be configured to determine dataset meta-features 106 of the dataset 102. In some embodiments, the dataset meta-features 106 may be characterizations of the dataset 102. For example, in these and other embodiments, the dataset meta-features 106 of the dataset 102 may include one or more of a number of rows, a number/quantity of features, the presence or absence of a value,, the presence of missing values, the presence of a number category, a presence of a string category, a presence of text, a median, a mean, a mode, a distribution, a maximum value, a minimum value, a label or title for the categories of information, among others. In some embodiments, the dataset meta-features 106 may include any suitable categorical description of data within the dataset 102. In some embodiments, a third-party tool may be used to extract the meta-features, such as Meta-Feature Extractor (MFE).

In some embodiments, the dataset meta-features 106 may be represented as a vector. For example, the dataset meta-features 106 may be represented as a vector containing one or more binary values, or all binary values. For instance, a 1 as a vector entry may indicate that a certain dataset meta-feature may be present while a 0 as a vector entry may indicate that the certain dataset meta-feature is not present. In some embodiments, the vector may be set at a certain fixed length. For example, a first entry may include a non-binary value representative of a number of rows in the dataset, a second entry may include a non-binary value representative of a number of columns, a third entry may include a binary value representative of whether or not the dataset includes a given value, a fourth entry may include binary value representative of whether or not the dataset is missing values (e.g., has blank cells for various entries in the dataset), a fifth entry may include binary value representative of whether or not the dataset includes values that are numbers, a sixth entry may include binary value representative of whether or not the dataset includes values that are strings, a seventh entry may include binary value representative of whether or not the dataset includes values that are text, an eighth entry may include a binary value representative of whether or not the dataset includes values that are dates, a ninth entry may include a non-binary value representative of skewness of the dataset, a tenth entry may include a non-binary value representative of Kurtosis of the dataset, an eleventh entry may include a non-binary value representative of normal distribution of the dataset, a twelfth entry may include a non-binary value representative of uniform distribution of the dataset, a thirteenth entry may include a non-binary value representative of Poisson distribution of the dataset, a fourteenth entry may include a non-binary value representative of normalized mean across columns of the dataset, a fifteenth entry may include a non-binary value representative of standard deviation across the columns of the dataset, a sixteenth entry may include a non-binary value representative of variation across the columns of the dataset, a seventeenth entry may include a non-binary value representative of Pearson correlation of the dataset, an eighteenth entry may include a non-binary value representative of a number of features that contain a threshold number of outliers, a nineteenth entry may include a non-binary value representative of number of features whose values are sparse, a twentieth entry may include a non-binary value representative of a number of features whose values are imbalanced, a twenty-first entry may include a non-binary value representative of a number of features whose values are dominant, a twenty-second entry may include a non-binary value representative of a type of target property as imbalanced, continuous or categorial, etc. In some embodiments, the dataset encoder 104 may be configured to generate the dataset meta-features 106 at a predetermined length (e.g., the first entry always corresponds to a number of rows, the second entry always corresponds to the number of columns, etc.). In some embodiments, the length of the dataset meta-features 106 may be determined based on types of data present in the dataset 102.

In some embodiments, the dataset encoder 104 may be configured to extract the dataset meta-features 106 from the dataset 102 by a statistical approach. For example, one or more statistics of the dataset 102 may be calculated and the one or more statistics may be used as one or more of the dataset meta-features 106. In these and other embodiments, the dataset encoder 104 may use any suitable statistical methods. For instance, the dataset encoder 104 may use SapienML to extract the dataset meta-feature 106. Additionally or alternatively, the dataset encoder 104 may use existing open-source software (OSS) packages such as PyMFE to extract the dataset meta-features 106 from the dataset 102. For example, PyMFE may be configured to extract certain types of meta-features. For instance, the types of meta-features may include one or more of general, statistical, information-theoretic, model-based, landmarking, relative landmarking, subsampling landmarking, clustering, concept, itemset, and complexity.

In some embodiments, the dataset 102 may be of any size. For example, dataset 102 may include any quantity of columns, which may vary across multiple inputs. In these and other embodiments, to accommodate datasets of different sizes, the dataset meta-features may include different levels of meta-features. For example, the dataset meta-features may include dataset-level meta-features and column-level meta-features. In some embodiments, the dataset-level meta-features may characterize the entire dataset. For example, the dataset-level meta-features may include number of columns and number of rows present in the dataset 102. In some embodiments, the column-level meta-features may provide column specific characteristics. In some embodiments, the column-level meta-features may be determined using a sequence model. For example, the tabular dataset 102 may be input to a sequence-to-sequence model to obtain the column-level meta-features. In some embodiments, the column-level meta-features may be determined following the same or similar approaches as described for the dataset-level meta-features. For example, the column-level meta-features may be determined using the statistical approach but with a single column as the input to the approach. By using different levels of meta-features, the decoder 120 may be able to adapt to datasets of different sizes.

In some embodiments, the dataset encoder 104 may be configured to adopt both the statistical approach and the ML based approach. For example, the data encoder 104 may extract the dataset meta-features 106 using both approaches. The results of the approaches may be combined to form the dataset meta-features 106. For instance, the results of multiple approaches may be concatenated to form the dataset meta-features 106.

The pipeline encoder 112 may be configured to determine pipeline meta-features 114 of the ML pipelines 110. In some embodiments, the pipeline meta-features 114 may include characteristics of each of the ML pipelines 110. In some embodiments, the characteristics of a given ML pipeline may include identification of preprocessing components present in the given ML pipeline, one or more ML operators and/or models included in the given ML pipeline, a predicted success rate of the ML pipeline, the absence or presence of a given ML model in the given pipeline, among others. In some embodiments, the pipeline meta-features 114 may be represented numerically and/or categorically. For example, the pipeline meta-features 114 may be represented as a set of numbers indicating presence of the preprocessing components. For instance, the pipeline meta-features 114 may be represented in a binary format where 0 indicates that a particular preprocessing component is not present and 1 indicates that the particular preprocessing component is present in a particular pipeline. As another example, the values or numbers may correspond to categorical values. In these and other embodiments, various encoding, such as OneHot encoding, may be used to represent the appearance of a particular option of a particular preprocessing component. In some embodiments, the preprocessing components may include one or more of data_cleaning_num (which may be configured to normalize, round, or otherwise process numerical values in the dataset such that the numerical values are in a consistent format), data_cleaning_catg (which may be configured to normalize, truncate, or otherwise process category labels in the dataset such that the category labels are in a consistent format), missing_num (which may be configured to identify whether or not a missing numerical value is present, and/or may be configured to automatically populate random values or zeros or some other value in fields where there are missing numbers), missing_catg (which may be configured to identify whether or not the dataset is missing a category label, and/or may be configured to automatically populate random values or a generic values such as “blank” or some other value in fields where there are missing category labels), missing_other (which may be configured to identify whether or not the dataset is missing other values or fields, and/or may be configured to automatically populate random values or a generic values such as zeros, a text string “blank,” or some other value in fields where there are other missing values or fields), datetime (which may be configured to transform raw data into a consistent date/time format, such as Apr. 20, 2023 08:04:55), text (which may be configured to performing processing on data to classify that data as text), URL (which may be configured to transform data into a consistent URL format), catg_encode (which may be configured to encode categorical variables into a numerical format), num_scaling (which may be configured to normalize a range of numerical values into a common scale), custom_fe (which may include any custom feature engineering process), pca (which may be configured to reduce dimensionality within the dataset while preserving key features of the dataset by identifying patterns in the dataset and generating new variables that may capture as much of variation in the dataset as possible), among others. In some embodiments, each of the preprocessing components may include one or more applicable options. For example, the num_scaling function may include StandardScaler (with_mean=False), StandardScaler (with_mean=True), log1p transformation, among others. In this example, different options of num_scaling may be represented as “num_scaling:[0:3]”, where “num_scaling:0” may represent not applying any numerical scaling functions, “num_scaling: 1” may represent applying the StandardScaler (with_mean=False), “num_scaling:2” may represent applying the StandardScaler (with mean=True), and “num_scaling:3” may represent applying the log1p transformation. In some embodiments, the pipeline meta-features 114 may be represented as a vector in a similar or comparable manner to that described above for the dataset meta-features 106.

In some embodiments, the pipeline meta-features 114 may include representations of the preprocessing components of the pipeline in either a simple representation or a complete representation, depending on the number of options or capabilities that are used for the preprocessing components of the pipeline meta-features 114. The simple representation may be utilized in instances where the same options of the preprocessing components are applied to groups of features with same data type. For example, a preprocessing component related to numerical features (e.g., “num_scaling”) may apply to all the groups of features with a numerical data type using the same options and in the same manner. In these and other embodiments, the pipeline meta-features 114 may be represented as a vector or other series of values where each value indicates different preprocessing components applied to each of the ML pipelines 110. For instance, the pipeline meta-features 114 may be represented as a table where columns may represent different preprocessing components, and each row may represent one pipeline of the ML pipelines 110. For example, each row may include a binary number for each column of the table, where 1 indicates that a particular preprocessing component in the column is applied to the ML pipeline and 0 indicates that the particular preprocessing component in the column is not applied to the ML pipeline. In some embodiments, the binary number for each column may be combined to represent the different preprocessing components for each pipeline as a vector.

In some embodiments, the pipeline meta-features 114 may be represented in a complete representation. The complete representation may be applicable in instances where different options of the preprocessing components may be applied to the groups of features with the same data type. In these and other embodiments, the pipeline meta-features 114 may represent which columns of the dataset 102 each of the preprocessing components is applied to. For example, the pipeline meta-features 114 in the complete representation format may include one or more entries, each entry indicative of whether a particular option of the preprocessing components is applied to a particular feature of the dataset 102. For instance, an entry of the complete representation may read 9_2_[0 1 1 1 1 1 1] where “9” represents the 9^{th} preprocessing component (e.g., encoding for categorical features), “2” represents option 2 (e.g., OneHot Encoder), and [0 1 1 1 1 1 1] represents that the preprocessing is applied to columns 2 through 7 for the associated ML pipeline. Or stated another way, the example complete representation may indicate that an encoding for categorical features is to be applied to columns 2 through 7 using the OneHot Encoder when the associated ML pipeline is utilized.

In some embodiments, the decoder 120 may be configured to obtain and utilize the dataset meta-features 106 and the pipeline meta-features 114 to generate pipeline predictions 122. For example, the decoder 120 may determine how each of the ML pipelines 110 may perform in analyzing or performing a designated task using the dataset 102. For example, the decoder 120 may determine how different preprocessing components present in the pipeline meta-features 114 may be applicable to different measures characterizing the dataset 102 represented by the dataset meta-features 106. In some embodiments, the pipeline predictions 122 may include a prediction of how likely a given ML pipeline is to successfully accomplish the ML task associated with the dataset 102. For example, in instances that the ML task includes a classification or a labeling task, the prediction may represent how likely the given ML pipeline is to properly classify the dataset as a whole, or the elements within the dataset. In some instances, the performance prediction may include one or more numerical scores representative of the performance or accuracy of a given ML pipeline. For example, for classification tasks, the score may be represented as an F1 score. In another example, for regression tasks, the score may be represented as an R² score. In some embodiments, any other existing evaluation metrics or customized evaluation metrics may be used. Additionally or alternatively, the performance prediction may include an execution time. For example, the execution time may predict and/or measure how much time each of the ML pipelines 110 may consume to train a ML model with the dataset 102 based on the associated ML pipeline and/or perform the identified ML task(s). In some embodiments, a second decoder may be trained to predict the execution time. For example, the second meta-model may replace or be in addition to the decoder 120. In some embodiments, the decoder 120 may be trained to account for both the numerical score and the execution time. In these and other embodiments, the decoder 120 may be configured to obtain a time budget indicative of a maximum time limit allowed, and to determine which of the ML pipelines 110 has the highest numerical score while finishing within the time budget. For example, stated mathematically, MaxΣᵢaᵢSᵢ such that ΣᵢaᵢTᵢ<B_{T}, where aᵢ represents a binary variable indicative of whether i-th pipeline of the ML pipelines 110 may be selected in the pipeline predictions 122, Sᵢ represents the numerical score of the prediction (e.g., how effective the aᵢ pipeline was at performing the task), Tᵢ represents the predicted execution time, and B_{T} represents the time budget. In instances where the performance prediction includes the one or more scores, the numerical score may be represented as an average of the one or more scores.

In some embodiments, the dataset encoder 104, the pipeline encoder 112, and/or the decoder 120 may include code and/or routines configured to enable a computing device to perform one or more operations. Additionally or alternatively, the dataset encoder 104, the pipeline encoder 112, and/or the decoder 120 may be implemented using hardware including a processor, a microprocessor (e.g., to perform or control performance of one or more operations), a field-programmable gate array (FPGA), or an application-specific integrated circuit (ASIC). In some other instances, the dataset encoder 104, the pipeline encoder 112, and/or the decoder 120 may be implemented using a combination of hardware and software. In the present disclosure, operations described as being performed by the decoder 120 may include operations that the dataset encoder 104, the pipeline encoder 112, and the decoder 120 may direct a corresponding system to perform. In some embodiments, the dataset encoder 104, the pipeline encoder 112, and/or the decoder 120 may be implemented on independent and separate hardware or may be implemented on shared or joint hardware.

Modifications, additions, or omissions may be made to FIG. 1 without departing from the scope of the present disclosure. For example, the system 100 may include more or fewer elements than those illustrated and described in the present disclosure.

FIG. 2 illustrates an example diagram 200 with a set of operations that may be performed to train a meta-model 230 that predicts top performing pipelines 255. The operations may be performed by any suitable system or device. For example, one or more operations of the diagram 200 may be performed by or directed for performance by the dataset encoder 104, the pipeline encoder 112, and/or the decoder 120 of FIG. 1. Additionally or alternatively, one or more operations of the diagram 200 may be performed by a computing system such as the computing system 800 of FIG. 8.

In general, the diagram 200 may be configured to perform one or more operations with respect to tabular datasets 210 and a candidate tabular dataset 240 to train the meta-model 230 and to predict a set of top performing pipelines 255. In some embodiments, the operations may include a preliminary pipelines synthesis operation 220, a model training operation 225, a candidate pipelines generation operation 245, and a performance prediction operation 250. In some embodiments, the operations may be divided into different phases. For example, an exploratory offline phase may include data and/or operations labeled 210, 220, 225, and 230. A generative online phase may include data and/or operations labeled 240, 245, 250, and 255. The operations of the exploratory offline phase and the generative online phase may each be performed by a system such as the system 100 of FIG. 1. For example, the tabular datasets 210 and the candidate tabular dataset 240 may each be analogous to the dataset 102 of FIG. 1.

In some embodiments, during the exploratory offline phase, the preliminary pipeline synthesis 220 may include operations to synthesize one or more preliminary pipelines 222 based at least on the tabular datasets 210 and one or more existing ML projects. In some embodiments, the one or more existing ML projects may be obtained from a ML project corpus. The ML project corpus may include any suitable repository of the one or more existing ML projects. Each existing ML project may include at least an existing dataset, an ML task defined on the existing dataset, and an ML pipeline. In some embodiments, the ML project corpus may include one or more open-source ML project databases, which may be large-scale repositories of existing ML projects (e.g., Kaggle and GitHub). In some embodiments, one or more functional blocks may be determined from the one or more existing ML projects. For example, the one or more functional blocks may be different types of functions that may be present in the one or more existing ML projects. For instance, the one or more functional blocks may organize different functions that may be performed by the ML pipeline on the existing dataset to perform the ML task.

In these and other embodiments, the preliminary pipelines 222 may be synthesized using the one or more functional blocks. For example, different features of the tabular datasets 210 may be extracted. Functional blocks corresponding to the different features may be determined from the one or more functional blocks. For example, a functional block may correspond with a feature by being suitable to be used to analyze the feature, such as a preprocessing operation that normalizes numerical values to a same format and number of decimal places for datasets that include numerical values. In some embodiments, the functional blocks corresponding to the different features may be used to synthesize preliminary pipelines 222.

The model training 225 may include operations that may be used to generate and train the meta-model 230. In some embodiments, the meta-model 230 may be trained to predict performance of a given pipeline on a given dataset.

In some embodiments, the meta-model 230 may be trained based at least on the tabular datasets 210 and the synthesized preliminary pipelines. In some embodiments, each of the preliminary pipelines 222 may be evaluated. For example, the tabular datasets 210 may be used to train and evaluate each of the preliminary pipelines 222. In these and other embodiments, a ML model using each of the preliminary pipelines 222 may be trained. In these and other embodiments, the tabular datasets 210 may be split into a training subset and a validation subset. In some embodiments, the tabular datasets 210 may be split in in any suitable proportions. For example, in some instances, the training subset may be 75% of the tabular datasets 210 while the validation subset is 25% of the tabular datasets 210. In these and other embodiments, the training subset may be used as input data to train the ML models of the various preliminary pipelines.

In some embodiments, the validation subset may be used to confirm performance of the preliminary pipelines 222. For example, after training each of the ML models for each of the preliminary pipelines 222, each of the respective preliminary pipelines may be requested to perform the task on a given dataset of the validation subset and the performance of the pipeline may be compared to the actual result for the given dataset (e.g., for a classification task, a determination may be made whether the preliminary pipeline properly classified the validation subset). In these and other embodiments, the performance may be represented as one or more scores. For example, the one or more scores may represent the performance numerically using any suitable metrics related to ML models. For example, a F1 score may be used for classification tasks. The F1 score may indicate precision of the preliminary pipeline. In another example, a R² score may be used for regressions tasks. The R² score may be a statistical measure of how well a regression prediction approximates real data points. Additionally or alternatively, the performance may include an execution time of the preliminary pipeline. For example, the execution time may predict how long the preliminary pipeline may take to obtain an input and process an output. In some embodiments, the execution time may be a function of, be proportional to, or may otherwise be related to a size of the dataset under consideration.

In some embodiments, the performance of the preliminary pipelines 222 may be stored. For example, the performance of the preliminary pipelines 222 may be stored in a database. In some embodiments, the database may store the performance as a performance table. For example, columns of the performance table may include a label for each of the preliminary pipelines 222 and performance evaluations such as the score and/or the execution time. Rows of the performance table may include actual scores of each of the preliminary pipelines 222.

In some embodiments, dataset meta-features may be derived from the tabular datasets 210. The dataset meta-features may be similar or comparable to those described with reference to FIG. 1. In some embodiments, deriving the dataset meta-features may include one or more operations as described with respect to FIG. 1 corresponding to extracting the dataset meta-features 106.

In some embodiments, pipeline meta-features may be derived from the preliminary pipelines 222. The pipeline meta-features may be similar or comparable to those described with reference to FIG. 1. In some embodiments, the deriving of the pipeline meta-features may include one or more operations described with respect to FIG. 1 corresponding to determining the pipeline meta-features 114.

In some embodiments, the dataset meta-features and the pipeline meta-features may be combined into a combined representation. For example, in some instances, the dataset meta-features and the pipeline meta-features may be represented as vectors. In these instances, the vectors may be concatenated to form a single vector. In some embodiments, the dataset meta-features and the pipeline meta-features may be combined using any suitable approach.

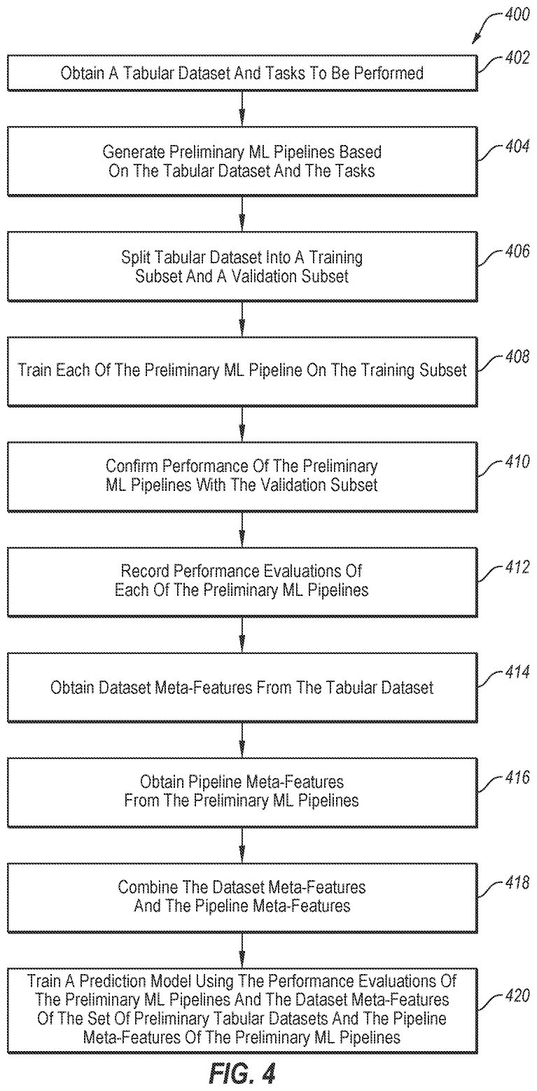

In some embodiments, the meta-model 230 may be trained based at least on the database including the preliminary pipelines 222 and their respective performances, and the combined representation of the dataset meta-features and the pipeline meta-features. For example, the meta-model 230 may be configured to identify correlations between meta-features of a dataset and meta-features of a pipeline that performs well for a designated task. Or stated another way, the meta-model 230 may be able to identify which combination of meta-features of a ML pipeline are effective on a given combination of dataset meta-features. In doing so, the meta-model 230 may be trained to predict performance of a given pipeline on a given dataset. In some embodiments, the meta-model 230 may be configured to predict performance using performance metrics such as F1 and/or R². In some embodiments, the meta-model 230 may be configured to evaluate performance using any other suitable metrics or customized metrics. For example, for classification tasks, performance metrics may include accuracy, precision, recall, receiver operating characteristic curve area under the curve (roc_auc), among others. For regression tasks, the performance metrics may include mean absolute error (MAE), mean square error (MSE), root of MSE (RMSE), among others. In some embodiments, the candidate tabular dataset 240 may include information on specific performance metrics to be applied to the candidate tabular dataset 240. In these instances, the meta-model 230 may be trained to evaluate performance of a given pipeline using the specific performance metrics. Training the meta-model 230 may be described in greater detail with reference to FIG. 4 of the present disclosure.

In these and other embodiments, this exploratory off-line phase may be repeated any number of times for any number of datasets and/or ML pipelines. By doing so, a robust model may be developed that is able to accurately identify effective ML pipelines for consideration for the candidate tabular dataset 240.

In some embodiments, during the generative online phase, the candidate tabular dataset 240 may be obtained. In some embodiments, the candidate tabular dataset 240 may be an unseen dataset. For example, the candidate tabular dataset may be a dataset that has not been processed by the meta-model 230. In some embodiments, the candidate tabular dataset 240 may include tasks to be performed on the candidate tabular dataset 240. Additionally or alternatively, a user or other actor may designate the task to be performed.

The candidate pipeline generation 245 may include operations that may be used to generate candidate ML pipelines 248 based at least on the candidate tabular dataset 240 and the tasks. In some embodiments, the candidate pipeline generation 245 may be analogous to the preliminary pipeline synthesis 220. For example, the candidate pipeline generation 245 may include the operations included in the preliminary pipeline synthesis 220 using the candidate tabular dataset 240 instead of the tabular datasets 210. For instance, one or more candidate pipelines may be generated based on features of the candidate tabular dataset 240 and the one or more functional blocks determined from the one or more existing ML projects that may facilitate performance of the task. In some embodiments, the candidate pipeline generation 245 may include generating different options of the preprocessing components and ML models for the candidate ML pipelines 248 without synthesizing actual pipelines themselves. For example, the candidate ML pipelines 248 may not be fully synthesized pipelines as the preliminary pipelines 222. In these and other embodiments, as fully synthesized pipelines may not be generated, the candidate pipeline generation 245 may be operated faster than the preliminary pipeline synthesis 220.

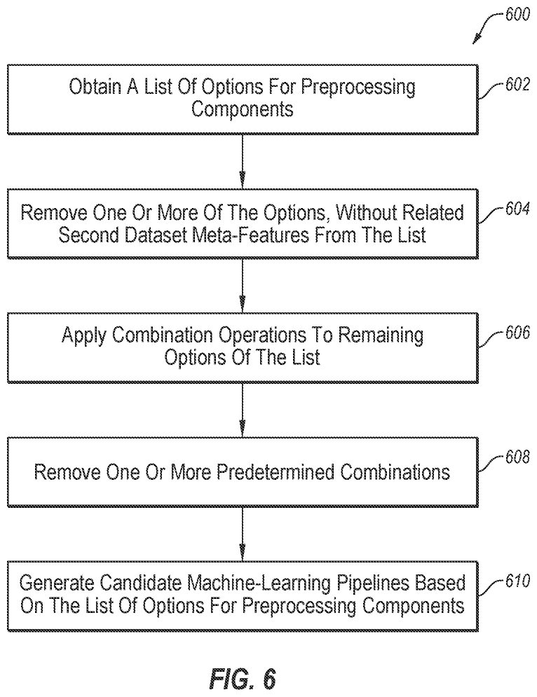

In some embodiments, the candidate pipeline generation 245 may include operations to remove certain preprocessing components. For example, the certain preprocessing components may not be applicable to the candidate tabular dataset 240. For instance, the candidate tabular dataset 240 may not include feature types to which various preprocessing components are applicable. For example, a preprocessing component be configured to preprocess numerical features (e.g., “num_scaling”). Continuing the example, in instances in which the candidate tabular dataset 240 does not include any numerical features, the num_scaling preprocessing operation may be removed. In some embodiments, combination operations may be applied to preprocessing components that are not removed. For example, different combinations of the preprocessing components may be determined. In some embodiments, the combined preprocessing components may be filtered again to remove any obvious errors. For example, a combined preprocessing components may include an option without missing numerical (“missing_num”) and principal component analysis (PCA). Such a combination may be removed due to incompatibility between no missing_num and PCA. Removing various preprocessing components may be further illustrated and described in the present disclosure with reference to FIG. 6.

The performance prediction 250 may include operations that may be used to predict performance of the candidate ML pipelines 248 on the candidate tabular dataset 240 when performing a designated task. In some embodiments, the meta-model 230 may be used to predict the performance of the candidate ML pipelines 248. In these and other embodiments, the performance prediction 250 may include operations related to obtaining dataset meta-features of the candidate tabular dataset 240 and pipeline meta-features of the candidate pipelines. For example, the dataset meta-features generated from the candidate tabular dataset 240 may be candidate dataset meta-features as compared to the dataset meta-features derived when training the meta-model 230. In some embodiments, the generating of the dataset meta-features may include one or more operations similar or comparable to those described with respect to FIG. 1 corresponding to determining the dataset meta-features 106, and with respect to FIG. 2 corresponding to determining the dataset meta-features from the tabular datasets 210.

In some embodiments, candidate pipeline meta-features may be extracted from the candidate ML pipelines 248. For example, the candidate pipeline meta-features may include characteristics of each of the candidate ML pipelines 248. In some embodiments, the generation of the candidate pipeline meta-features may be performed in a similar or comparable manner to that described with respect to FIG. 1 corresponding to determining the pipeline meta-features 114. In some embodiments, the candidate pipeline meta-features may be generated directly from the candidate tabular dataset 240 without generating the candidate ML pipelines 248, as indicated by the dashed arrow 249. In some embodiments, the candidate dataset meta-features and the candidate pipeline meta-features may be combined into a combined representation which may be used during the performance prediction 150. For example, the combined representation may be derived and then provided to the meta-model 230. The meta-model 230 may use the combined representation to predict performance of the candidate ML pipelines 248 in performing the designated task. In some embodiments, the performance of the candidate ML pipelines 248 may be measured as a performance score. For example, in some embodiments, a conventional scoring metrics such as F1 score or R² score may be used. In other embodiments, custom score metrics designed for the candidate tabular dataset 240 and a specific task to be performed on the candidate tabular dataset 240 may be used. In these and other embodiments, the performance may also include an execution time. For example, the performance prediction may include prediction of an expected execution time of each of the candidate ML pipelines 248 to perform the designated task for the candidate tabular dataset 240.

In some embodiments, a set of top performing pipelines 255 may be identified based on the performance. For example, in some embodiments, the top performing pipelines 255 may be selected from the one or more candidate pipelines based on a threshold. In some embodiments, the threshold may indicate a specific number of pipelines to be selected. For example, the five highest performers of the candidate ML pipelines 248 may be selected based on their respective predicted performance scores and/or their predicted execution time. In other embodiments, the threshold may be performance-based. For example, the threshold may include a threshold performance score. In these and other embodiments, any number of the candidate ML pipelines 248 that meet and/or exceed the threshold performance score may be selected as the top performing pipelines 255. In another embodiment, the threshold may define a threshold execution time. For example, any number of the candidate ML pipelines 248 that may be predicted to complete the task within the threshold execution time may be selected as the top performing pipelines 255. In some embodiments, the threshold execution time may be determined based on a time budget. For example, longer execution time may lead to higher cost of operation. The threshold execution time may limit the cost by selecting pipelines with shorter execution time. In another example, a system may require a certain execution time. In some embodiments, multiple thresholds may be used in combination. For example, the top five performing ML pipelines with an execution time below thirty seconds may be selected.

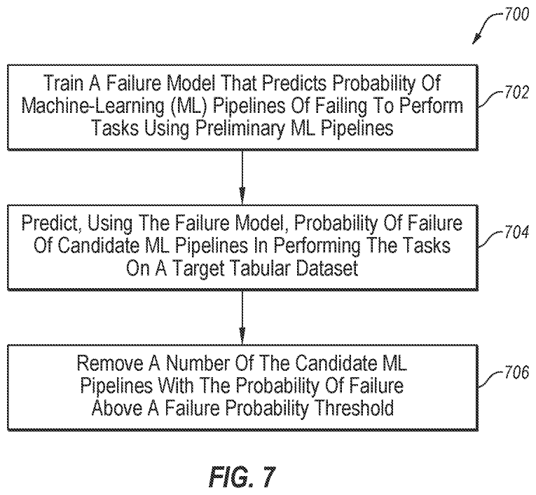

In some embodiments, the diagram 200 may include a failure meta-model 235 that may be configured to detect candidate pipelines with high probability of failure. For example, the failure meta-model 235 may be configured to remove pipelines that are likely to fail due to an error or a timeout. In some embodiments, the failure meta-model 235 may be trained during the exploratory offline phase. For example, the failure meta-model 235 may be trained using the one or more preliminary ML pipelines. For instance, the one or more preliminary ML pipelines may be executed and those that fail to execute properly may be determined. The failed preliminary ML pipelines may be used to train the failure meta-model 235 that may predict a probability of failure of a given pipeline. In some embodiments, training the failure meta-model 235 may be performed in a similar or comparable manner to that described with the meta-model, but in terms of failures rather than performance score. For example, the failure meta-model 235 may be configured to utilize meta-features of the dataset and/or pipelines to predict how likely a candidate pipeline is to fail in performing the designated task on the candidate dataset. Training the failure meta-model 235 may be described with more detail in reference to block 702 of FIG. 7 of the present disclosure.

In some embodiments, the failure meta-model 235 may be used during the generative online phase to filter the candidate ML pipelines 248 to remove pipelines with high probability of failure. For example, the failure meta-model 235 may obtain the candidate ML pipelines 248 and the candidate tabular dataset 240. In these and other embodiments, the failure meta-model 235 may predict the probability of failure for each of the candidate ML pipelines 248. In some embodiment, the candidate ML pipelines 248 with the probability of failure above a failure probability threshold may be removed. For instance, the removed pipelines may not be considered in determining the top-performing pipelines 255. In some embodiments, the candidate ML pipelines 248 may be run through the failure meta-model 235 prior to the meta-model 230. For example, the pipelines with a high probability of failure may be removed prior to predicting performance of the pipelines. In other embodiments, the candidate ML pipelines 248 may be run through the failure meta-model 235 after being evaluated by the meta-model 230.

In some embodiments, the top performing pipelines 255 may be trained to evaluate performance. For example, for each of the top performing candidate pipelines 255, corresponding ML models within the top performing candidate pipelines may be trained. For example, the candidate tabular data 240 may be split into a training subset and a validation subset. The ML model for each of the top performing pipelines 255 may be trained using the training subset and validated using the validation subset. In some embodiments, a single or apex top-performing ML pipeline may be identified based on the evaluation. In some embodiments, the training subset and the validation subset may be split in different variations (e.g., different ratios or training vs. validation subsets, same ratios with different portions of the dataset in the training vs. validation subset, or both). The different variations of the training subset and the validation subset may be used to train and validate the ML model for each of the top performing pipelines 255. In these and other embodiments, the single or apex top-performing ML pipeline may be identified based on average performance of the top performing pipelines 255 across the different variations of the training subset and the validation subset.

Modifications, additions, or omissions may be made to FIG. 2 without departing from the scope of the present disclosure. For example, the diagram 200 may include more or fewer elements than those illustrated and described in the present disclosure.

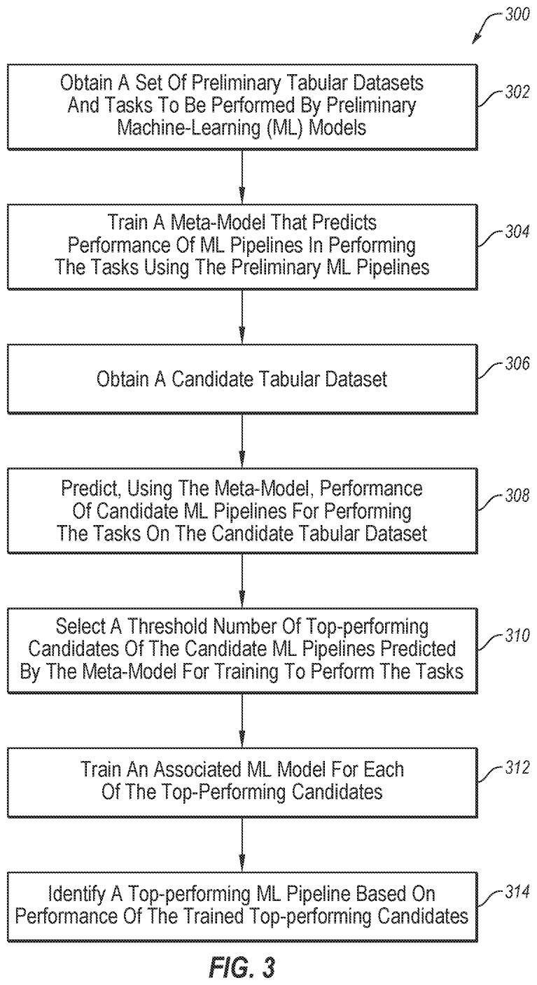

FIG. 3 illustrates an example flowchart of an example method 300 of training a ML model and predicting top-performing pipelines, in accordance with one or more embodiments of the present disclosure. For example, the method 300 may be an example of or an expansion of the operations set of the diagram 200 of FIG. 2. One or more operations of the method 300 may be performed by a system or device, or combinations thereof, such as the system 100, and/or a computing system 800. Although illustrated as discrete blocks, various blocks of the method 300 may be divided into additional blocks, combined into fewer blocks, or eliminated, depending on the implementation.

At block 302, preliminary tabular datasets and tasks to be performed by preliminary ML pipelines may be obtained. For example, the preliminary tabular datasets (such as the preliminary tabular datasets 210 of FIG. 2 or the tabular datasets 102 of FIG. 1) may be obtained. As another example, preliminary ML pipelines (such as the preliminary pipelines 222 of FIG. 2 or the pipelines 110 of FIG. 1). The tasks may depend on the type of data present in the preliminary tabular datasets. For example, the tasks may include regression and/or classification.

At block 304, a meta-model configured to predict performance of ML pipelines in performing the tasks may be trained using the preliminary ML pipelines and/or the preliminary tabular datasets. In some embodiments, each of the one or more preliminary ML pipelines may be trained and evaluated using the preliminary tabular datasets. For example, the preliminary tabular datasets may be divided into a training subset and a validation subset. The training subset may be used to train ML model(s) of the one or more preliminary ML pipelines. The trained preliminary ML pipelines may have their performance evaluated based on performance of the tasks using the validation subset of the data. The performances may be stored and used to correlate performance with meta-features of the preliminary datasets and meta-features of the preliminary pipelines.

In some embodiments, the block 304 may be iteratively repeated for continual training of the meta-model during an exploratory phase such that a large number of preliminary pipelines may be assessed, and an accurate predictive model may be built. For example, the meta-model may explore tens, hundreds, thousands, tens of thousands, hundreds of thousands, millions, tens of millions, or hundreds of millions of ML pipelines.

At block 306, a candidate tabular dataset may be obtained. For example, the candidate tabular dataset may include a dataset for which a task is desired to be performed using a ML model, such as a classification task, or a regression task. In some embodiments, one or more candidate ML pipelines may be generated based on the candidate tabular dataset and/or the task to be performed. The candidate ML pipelines may be generated in a similar manner as the preliminary ML pipelines. In some embodiments, the candidate tabular datasets may include candidate tasks to be performed on the candidate tabular dataset.

At block 308, the meta-model may be used to predict performance of the candidate ML pipelines for performing the candidate tasks on the candidate tabular dataset. In some embodiments, the predicted performance may relate to accuracy of the candidate ML pipelines. In these and other embodiments, the predicted performance may be represented as one or more scores. For example, an existing score metric such as F1 and R² may be used. In another example, any custom score metrics may be used. In these and other embodiments, the one or more scores may be represented numerically. In some embodiments, the predicted performance may relate to an execution time. For example, the meta-model may be configured to predict how long the one or more candidate ML pipelines may take to execute fully. In some embodiments, the predicted performance may include both the one or more scores and the execution time. In other embodiments, any suitable performance measurements may be used as the predicted performance. In these and other embodiments, the prediction may be based on the meta-features of the candidate dataset and the meta-features of the candidate ML pipelines. For example, the meta-model may receive as inputs the meta-features of the candidate dataset, the meta-features of the candidate ML pipelines, and/or the candidate task(s), and may provide a prediction of the effectiveness of the candidate ML pipelines in performing the candidate task(s) for the candidate dataset.

At block 310, a threshold number of top-performing candidates of the candidate ML pipelines may be selected. For example, the threshold number may define a specific number of the candidate ML pipelines to be selected. In these instances, the specific number of the candidate ML pipelines with the best predicted performances may be selected. In some embodiments, the threshold number may define a predicted performance threshold. For example, the predicted performance threshold may indicate a specific score and/or execution time to be met. In these instances, any number of the one or more candidate ML pipelines that meet or exceed the specific score and/or execution time may be selected.

At block 312, an associated ML model for each of the top-performing candidates may be trained. For example, the associated ML model may be trained based on the candidate tabular datasets, options of preprocessing components, ML algorithm associated with the top-performing candidates, and/or the candidate task(s). The trained ML models may be used to evaluate actual performance of the top-performing candidates for the candidate tabular dataset.

At block 314, an apex top-performing ML pipeline may be identified according to the evaluation of validation performance of the top-performing candidates. In some embodiments, an apex top-performing ML pipeline may be selected based on the validation performance. A number of pipelines to be identified as the top-performing ML pipelines may vary according to different ML projects.

By selecting the threshold number of top-performing candidates at the block 310, computing resources may be saved and the operation of the system may be improved. For example, the system may not have to perform as much training at the block 314 since only a limited number of candidate ML pipelines are actually trained and tested because the meta-model of the block 310 is able to filter the candidate ML pipelines down to a limited number of top performers.

Modifications, additions, or omissions may be made to the method 300 without departing from the scope of the disclosure. For example, the operations of the method 300 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 4 illustrates an example flowchart of an example method 400 of training a meta-model, in accordance with one or more embodiments of the present disclosure. For example, the method 400 may be an example of or an expansion of the preliminary pipeline synthesis 220, and/or the model training 225 of FIG. 2. Stated another way, the method 400 may be an example of an exploratory offline phase of an exploratory offline generative online machine learning model that results in a trained meta-model. One or more operations of the method 400 may be performed by a system or device, or combinations thereof, such as the system 100, and/or a computing system 800. Although illustrated as discrete blocks, various blocks of the method 400 may be divided into additional blocks, combined into fewer blocks, or eliminated, depending on the implementation.

At block 402, one or more tabular datasets and one or more tasks to be performed may be obtained. The tasks may include any ML task that may be used to analyze and/or classify data in the tabular dataset. In some embodiments, the tasks may be designated by the tabular datasets themselves. Additionally or alternatively, a user, programmer, or other individual may manually input the tasks.

At block 404, one or more preliminary ML pipelines may be generated based on the tabular datasets and the tasks. For example, the preliminary ML pipelines may include one or more preprocessing components suitable for the data in the tabular datasets. In some embodiments, generating the preliminary ML pipelines based on the tabular datasets and the tasks may include one or more of the operations describe with respect to FIG. 2 corresponding to synthesizing the preliminary pipelines 220.

At block 406, the tabular datasets may be split into a training subset and a validation subset. For example, a certain number of the tabular datasets may be used for training and other tabular datasets may be used for evaluation. As another example, a certain portion of a given tabular dataset may be used for training and the remainder of the given tabular dataset may be used for evaluation. In some embodiments, the split may be made in any suitable proportions. For example, the tabular dataset(s) may be split into 75% training subset and 25% validation subset. In another example, the tabular dataset(s) may be split into 50% training subset and 50% validation subset.

At block 408, each of the preliminary ML pipelines may be trained on the training subset. For example, a preliminary ML model of a given preliminary pipeline may be trained using the training subset.

At block 410, performance of the one or more trained preliminary ML pipelines may be confirmed and/or validated with the validation subset. For example, the preliminary ML model may receive the validation subset and determine how each of the preliminary ML pipelines performs on the validation subset.

At block 412, performance evaluations of the preliminary ML pipelines may be recorded. For example, the performance evaluations may be recorded in a database, where the databases may include a list of the preliminary pipelines and corresponding performance evaluations. In some embodiments, the performance evaluations may be represented as a known score metric such as F1 and/or R². Additionally or alternatively, the performance evaluation may be represented as a custom score metric. In these and other embodiments, the performance evaluation may or may not include an execution time. In some embodiments, the performance evaluation may include both the score and the execution time.

At block 414, dataset meta-features may be obtained from the tabular dataset(s). In some embodiments, the dataset meta-features may be characteristics of the tabular datasets. In some embodiments, the dataset meta-features may be represented as a vector.

At block 416, pipeline meta-features may be obtained from the one or more preliminary ML pipelines. In some embodiments, the pipeline meta-features may include characteristics of a given preliminary ML pipeline. In some embodiments, the characteristics of a given preliminary ML pipeline may include identification of preprocessing components present in the given preliminary pipeline, one or more ML operators and/or models included in the given preliminary pipeline, a predicted success rate of the preliminary pipeline, the absence or presence of a given ML model in the given preliminary pipeline, among others.

At block 418, the dataset meta-features and the pipeline meta-features may be combined. For example, the dataset meta-features and the pipeline meta-features may each be represented as a vector. The dataset meta-features and the pipeline meta-features may be concatenated into a single, larger vector. In some embodiments, the dataset meta-features and the pipeline meta-features may be combined using any suitable format and/or approach.

At block 420, a meta-model may be trained using the performance evaluations of the preliminary ML pipelines, the dataset meta-features, and the pipeline meta-features. For example, the meta-model may be trained to predict a performance of a given pipeline on a given dataset. In some embodiments, the meta-model may be configured to receive a candidate dataset and a candidate pipeline and predict how the candidate pipeline would perform in processing the candidate dataset based on the meta-features of the candidate dataset and the meta-features of the candidate pipeline. In some embodiments, the meta-model may be configured to generate one or more scores representative of the predicted performance. For example, the meta-model may generate numerical scores for the performance. In some embodiments, the meta-model may be configured to predict execution time of the pipeline in addition to or separately from the performance.

Modifications, additions, or omissions may be made to the method 400 without departing from the scope of the present disclosure. For example, the operations of the method 400 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

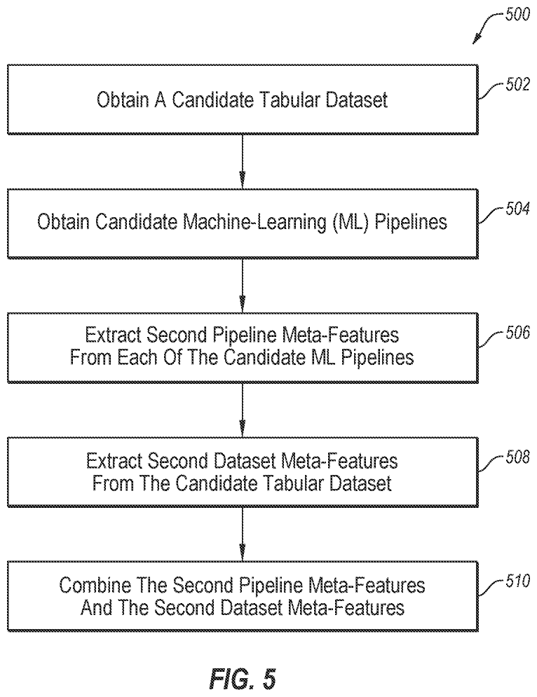

FIG. 5 illustrates an example flowchart of an example method 500 of generating meta-features during a generative online phase, in accordance with one or more embodiments of the present disclosure. For example, the method 500 may be an example of or an expansion of the candidate pipeline generation 245 and/or the predict performance 250 of FIG. 2. One or more operations of the method 500 may be performed by a system or device, or combinations thereof, such as the system 100, and/or a computing system 800. Although illustrated as discrete blocks, various blocks of the method 500 may be divided into additional blocks, combined into fewer blocks, or eliminated, depending on the implementation.

At block 502, a candidate tabular dataset may be obtained. In some embodiments, the candidate tabular dataset may include a set of tabular data that has not been presented to a trained meta-model previously. For example, the candidate tabular dataset may include the type of dataset that the meta-model was trained to analyze. In some embodiments, the candidate tabular dataset may include one or more ML tasks to be performed on the candidate tabular dataset. For example, the ML tasks may indicate how the candidate tabular dataset is to be analyzed.

At block 504, candidate ML pipelines may be obtained. In some embodiments, the candidate ML pipelines may be generated based at least on the candidate tabular dataset. For example, the candidate ML pipelines may be generated as options to perform the ML tasks on the candidate tabular dataset. For instance, the candidate ML pipelines may include functional blocks including different preprocessing components to be performed on the candidate tabular dataset. In some embodiments, the candidate ML pipelines may include functional blocks including different ML algorithms to be performed on the candidate tabular dataset. In some embodiments, the obtaining the candidate ML pipelines may include one or more operations described with respect to FIG. 2 corresponding to the generation of preliminary pipelines 245.

At block 506, candidate pipeline meta-features may be extracted for each of the candidate ML pipelines. For example, the candidate pipeline meta-features may include characteristics of each of the candidate ML pipelines. In some embodiments, the generation of the candidate pipeline meta-features may include one or more operations described with respect to FIG. 1 corresponding to determining the pipeline meta-features 114 of FIG. 1.

In some embodiments, the candidate pipeline meta-features may be representative of different preprocessing components applied to various columns of the candidate tabular dataset. For example, in some embodiments, the candidate pipeline meta-features may be represented as a one or more vectors representing each of the different preprocessing components being applied to each of the columns of the candidate tabular dataset. For example, in some embodiments, the candidate tabular dataset may include N columns and there may be M number of types of preprocessing components available in the candidate ML pipelines. In these and other embodiments, the vector may be represented as [PP_{1,1}, . . . PP_{1,M}, PP_{2,1}, . . . PP_{2,M}, . . . , PP_{N,1}, . . . PP_{N,M}], PP indicating preprocessing component that is being applied to the column. For instance, [PP_{1,1}, . . . PP_{1,M}] may represent the different preprocessing components applied to a first column of the candidate tabular dataset.

At block 508, candidate dataset meta-features may be extracted from the candidate tabular dataset. The block 508 may be comparable or similar to the block 414, although applied to the candidate dataset rather than the preliminary tabular dataset.

In some embodiments, the candidate dataset meta-features may include dataset-level meta-features and column-level meta-features. For example, the dataset-level meta-features may include statistics of the candidate tabular dataset as a whole. For instance, the dataset-level meta-features may characterize the entire candidate tabular dataset. In some embodiments, the column-level meta-features may characterize a specific column of the candidate tabular dataset. For example, each column of the candidate tabular dataset may include a different type of data characterization. In these and other embodiments, the column-level meta-features may be represented as a vector for a given dataset, or for a given column within a dataset.

At block 510, the candidate dataset meta-features and the candidate pipeline meta-features may be combined. For example, a single vector may be generated including the candidate dataset meta-features and the candidate pipeline meta-features. In some embodiments, the column-level dataset meta-features and the candidate pipeline meta-features associated with specific column of the column-level dataset meta-features may be combined. For example, the column-level dataset meta-features and the candidate pipeline meta-features may be concatenated. For instance, for each of the column-level dataset meta-features, a vector corresponding to the different preprocessing components for the respective column from the candidate pipeline meta-features may be determined and combined. For example, a vector representing the dataset meta-features for a column from the candidate tabular dataset and the different preprocessing components applied to that column may be generated and combined into a single combined vector.

In some embodiments, the vectors of the various columns may be combined into a single representation. For example, a single vector, matrix, table, or other data representation may be generated by combining the vectors. In some embodiments, any suitable techniques may be used to combine the vectors. For example, a sequence-to-one model may be applied to the vectors.

Modifications, additions, or omissions may be made to the method 500 without departing from the scope of the disclosure. For example, the operations of the method 500 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 6 illustrates an example flowchart of an example method 600 of removing one or more options for preprocessing components and/or generating candidate ML pipelines, in accordance with one or more embodiments of the present disclosure. For example, the method 600 may be an example of or an expansion of the candidate pipeline generation 245 of FIG. 2. One or more operations of the method 600 may be performed by a system or device, or combinations thereof, such as the system 100, and/or a computing system 800. Although illustrated as discrete blocks, various blocks of the method 600 may be divided into additional blocks, combined into fewer blocks, or eliminated, depending on the implementation.

At block 602, a list of options for preprocessing components may be obtained. In some embodiments, the list of options may be obtained from one or more existing ML projects, such as those stored in large repositories or open-source software projects or other repository or corpus of ML projects. For example, different preprocessing components present in the ML projects may be extracted from the ML projects.

In some embodiments, different options of the preprocessing components may be applied to features of the same data type. In these and other embodiments, enumeration of all processing options may be large enough to cause an issue with memory where a large number of features exist in a given dataset. For example, the memory may not be sufficient to store all the enumerations. In these and other embodiments, similar features may be clustered to limit the enumerations. For example, a candidate tabular dataset may include N samples (e.g., data) and M columns of the same feature type. Continuing the example, it may be determined that K preprocessing components may be applied to the candidate tabular dataset based on the list of options for preprocessing components. In these instances, a total number of the enumerations may be (K+1)\hat{ }M, which may be too large for the memory, resulting in decrease of performance, errors or failures, or other issues for a computing system. In these and other embodiments, the M columns may be clustered into m clusters. For example, each of the m clusters may include a part of the M columns. In some embodiments, any suitable clustering method may be used to cluster M columns into m clusters. For example, K-means clustering may be used to cluster M vectors of size N into m vectors of size N. As another example, random clustering may be used to cluster M columns into m clusters. By doing so, instead of tracking each individual column (e.g., M), the system may instead track a much smaller grouping of the individual clusters (e.g., m).

In instances where the memory is not an issue, m may be represented mathematically as m=[log_{K+1}MaxEnumNum], where MaxEnumNum may be the maximum number of enumerations allowed for a given preprocessing component. In other instances where the memory may be an issue, MaxEnumNum may be reduced iteratively until a memory constraint is satisfied. For example, stated mathematically, MaxEnumNum may be reduced for r iterations as MaxEnumNumᵣ₊₁=MaxEnumNumᵣ/2.

At block 604, one or more of the options from the list of preprocessing components options may be removed. For example, if a given preprocessing component is configured to operate on certain components of a dataset (e.g., a text string), if the meta-features of the dataset indicated that the dataset does not include that sort of a component (e.g., the dataset has no text strings), the given preprocessing component may be removed. In some embodiments, the block 604 may include comparing meta-features of a dataset with the list of options for preprocessing components. For example, it may be determined whether any given option of preprocessing is applicable to the tabular dataset. For example, a preprocessing component related to scaling numbers may not be applicable in instances in which the tabular dataset does not include any numerical features. In these instances, the preprocessing component related to scaling numbers may be removed. In another example, a preprocessing component related to categorical encoding may not be applicable in instances in which the tabular dataset does not include any categorical features.

In some embodiments, the options of preprocessing components may be modified to increase efficiency of storage. For example, when the type of data upon which the preprocessing component acts is not present in a given dataset, that preprocessing component may be removed. In such an embodiment, an option of disabling the preprocessing component may not be utilized. As such, the iteration of preprocessing options for that specific preprocessing component may be adjusted to remove the option of disabling the preprocessing component. For example, the options may include: “missing_num”:[0, 1], “catg_encode”:[0, 1, 2], “pca”:[0, 1], and “model”:[1, 2]. When any feature in the given dataset belongs to the categorical data type, a categorical encoder may be utilized and “catg_encode:0,” representing no application of a category encoder may be removed, which may result in the application of at least one option of the categorical encoder (e.g., “catg_encode:1” or “catg_encode:2”) to each categorical feature. In some embodiments, applying the categorical encoder (e.g., OneHot Encoder) may cause a memory issue due to generating an excessive number of dummy variables (e.g., columns) for a large number of categorical columns or for including an excessive number of categories in a categorical column. In these and other embodiments, various categorical encoder options (e.g., using OneHot Encoder) may not be used to avoid memory issues.

At block 606, combinatorial operations may be applied to any remaining options for preprocessing from the list remaining after the block 604. For example, the combinatorial operations may determine any possible combinations among the remaining options. For example, in some instances, the remaining options may include the following preprocessing operations with associated options: “missing_num”:[1], “catg_encode”:[1, 2], “pca”:[0, 1], and “model”:[1, 2]. Continuing the example, the combinatorial operations may lead to eight different combination configurations: (“missing_num”:1,“catg_encode”:1, “pca”:0, “model”:1), . . . (“missing_num”:1, “catg_encode”:2, “pca”:2, “model”:2).

At block 608, the set of different combination configurations may be filtered to remove various predetermined combination configurations. For example, the combination configurations may be filtered to remove any combination configurations that may cause obvious error or otherwise be logically incompatible. For example, the predetermined combination configurations may include a combination of missing number and principal component analysis (PCA). For example, continuing the example from block 606, “pca” may or may not be excluded for a dataset with missing numerical features since numerical missing value handling might be applied. However, “pca” may not function properly or otherwise be combined with “missing_num” without causing an error. In these instances, the combination configurations with “missing_num: 0” and “pca”:1, which represent none missing numerical handling and a first version of PCA component, respectively, may be removed.

At block 610, one or more candidate ML pipelines may be generated based on the list of the remaining options. For example, each of the candidate ML pipelines may include one or more preprocessing components selected from the remaining options. Additionally or alternatively, the preprocessing components may be combined or included in combinations identified in the block 608.

Modifications, additions, or omissions may be made to the method 600 without departing from the scope of the disclosure. For example, the operations of the method 600 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 7 illustrates an example flowchart of an example method 700 of training a failure model to predict and remove pipelines with high probability of failure, in accordance with one or more embodiments of the present disclosure. For example, the method 700 may be an example of or an expansion of the candidate pipeline generation 245 of FIG. 2. One or more operations of the method 700 may be performed by a system or device, or combinations thereof, such as the system 100, and/or a computing system 800. Although illustrated as discrete blocks, various blocks of the method 700 may be divided into additional blocks, combined into fewer blocks, or eliminated, depending on the implementation.

At block 702, a failure model configured to predict probability of ML pipelines failing to perform tasks using preliminary ML pipelines may be trained. The training of the failure model may be comparable or similar to that described herein for training the meta-model, but may measure the likelihood of failure rather than a likelihood of success. In some embodiments, the failure model may be configured to predict candidate pipelines that are likely to fail due to an error or a timeout. In some embodiments, information regarding whether a pipeline fails to complete execution may be recorded or observed during the evaluation of performance for preliminary ML pipelines. For example, the preliminary ML pipelines may fail to fully execute on a tabular dataset due to an error or timeout. In some embodiments, the information regarding failure to execute may be represented as binary indications. For example, a failed execution may be represented as 1 and a successful execution may be represented as 0. In some embodiments, the binary indications and the preliminary ML pipelines may be used to train the failure model. For example, the failure model may determine meta-features of the preliminary ML pipelines that were related to failure to execute. In some embodiments, the failure model may be trained to determine a failure probability within a failure range. For example, the failure probability may be represented as a real number (e.g., between 0 and 1), with a higher value indicating a higher probability of failure.

At block 704, the failure model may be used to predict probability of failure of one or more candidate ML pipelines in performing the tasks on a candidate tabular dataset. For example, the failure model may obtain the candidate tabular dataset and the candidate ML pipelines generated based on the candidate tabular dataset. In some embodiments, the failure model may determine the probability of failure for each of the one or more candidate ML pipelines. For example, each of the candidate ML pipelines may be assigned a number within the failure range representing the probability of failure.

At block 706, a number of the candidate ML pipelines with the probability of failure above a failure probability threshold may be removed from consideration as a top-performing candidate ML pipeline. In some embodiments, the failure probability threshold may be represented as a number within the failure range. For example, on the failure range from 0 to 1, the failure probability threshold may be determined as 0.4. In some embodiments, the failure probability threshold may be determined based on different parameters. For example, the failure probability threshold may be determined based on time budget. For instance, when the time budget is low, the failure probability threshold may be determined as a low number to remove more pipelines. In some embodiments, the probability of failure associated with each of the candidate ML pipelines may be compared against the failure probability threshold. For example, the candidate ML pipelines with an associated probability of failure that meets and/or exceeds the failure probability threshold may be removed. In these and other embodiments, the removed candidate ML pipelines may not be further used, and may otherwise be discarded or purged.

Modifications, additions, or omissions may be made to the method 700 without departing from the scope of the disclosure. For example, the operations of the method 700 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 8 illustrates a diagram representing an example system 800 related to automatically generating a new machine learning pipeline based on a dataset, according to at least one embodiment of the present disclosure. The system 800 may include an on-premises server 802 and a ML server 804. In some embodiments, the on-premises server 802 may be located within a premises of a user. For example, the on-premises server may be located within a data center privately owned and controlled by the user. In these and other embodiments, the ML server 804 may be located off the premises of the user. For example, the ML server may be located within a data center owned and controlled by a service provider. The service provider may be an entity providing inference services to provide a meta-model that may be custom designed for the user.

In some embodiments, the on-premises server 802 may be configured to extract dataset meta-features 806 from a dataset. In some embodiments, the dataset may include publicly available data. Additionally or alternatively, the dataset may include data privately owned by the user. For example, the dataset may include confidential data owned by the user. In some embodiments, the on-premises server 802 may be configured to extract the dataset meta-features 806 following any suitable operations described in the present disclosure such as extracting the dataset meta-features 106 of FIG. 1 and/or block 508 of FIG. 5.

In some embodiments, the on-premises server 802 may transmit the dataset meta-features 806 to the ML server 804. In these and other embodiments, contents of original dataset may not be transmitted to the ML server 804. For example, only the dataset meta-features 806 characterizing the dataset may be transmitted without transmitting contents of the dataset. By not transmitting the contents of the dataset, the user may preserve confidentiality of the dataset form the service provider. In these and other embodiments, the ML server 804 may be configured to provide ML pipelines 808 to the on-premises server 802. For example, the ML server 804 may generate the ML pipelines 808 based on the dataset meta-features 806. In some embodiments, the ML pipelines 808 may be generated following any suitable approaches described in the present disclosure.

In some embodiments, a quantity of the ML pipelines 808 provided by the ML server 804 may vary according to the type of service requested by the user. For example, the user may request a pure prediction service where the user is merely seeking to obtain the ML pipelines 808. In these instances, the ML server 804 may provide a relatively small quantity (e.g., 10) of the ML pipelines 808. In other embodiments, the user may seek a training service where the user may be seeking a service with a custom meta-model. In these instances, the ML server 804 may provide a relatively large number (e.g., hundreds, thousands, or tens of thousands) of the ML pipelines 808. In some embodiments, various aspects (e.g., programming code) of the meta-model itself may be kept within the ML server 804 or the service provider, which may permit the user to keep their data confidential while the service provider may maintain aspects of the meta-model confidential.

In some embodiments, the on-premises server 802 may obtain the ML pipelines from the ML server 804. The on-premises server 802 may be configured to execute the ML pipelines 808 to facilitate training of the meta-model at the service provider based on the performance of the ML pipelines 808. For example, the on-premises server 802 may use each of the ML pipelines 808 to perform the task on their confidential data and store the results of the task as an evaluation result.

In some embodiments, the ML server 804 may obtain evaluation results 810 of the ML pipelines 808 from the on-premises server 802. In these and other embodiments, the ML server 804 may be configured to utilize the evaluation results 810 to train the meta-model based on the performance of the ML pipelines 808, despite not having access to the data of the user. For example, the meta-model may be customized to the user based on the dataset meta-features 806, the ML pipelines 808, and the evaluation results 810. For example, the meta-model may be trained to predict performance of a given ML pipeline without actually accessing a raw dataset. For instance, the meta-model may receive as inputs the dataset meta-features, meta-features of a given ML pipeline, and/or a task(s) to be performed, and may provide a prediction of the effectiveness of the given ML pipeline in performing the task(s) for the dataset. In doing so, the meta-model may have been trained on data specific to the user such that the meta-model is a good indicator of performance for the specific type of data that the user utilizes.

Modifications, additions, or omissions may be made to FIG. 8 without departing from the scope of the present disclosure. For example, the system 800 may include more or fewer elements than those illustrated and described in the present disclosure.

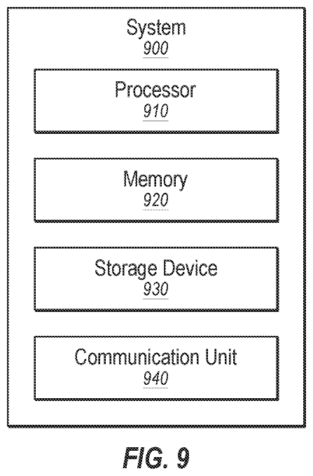

FIG. 9 is a block diagram illustrating an example system 900 that may be used for training a meta-model and predicting performance of candidate ML pipelines, according to at least one embodiment of the present disclosure. The system 900 may include a processor 910, memory 912, a communication unit 916, a display 918, and a user interface unit 920, which all may be communicatively coupled. In some embodiments, the system 900 may be used to perform one or more of the methods described in this disclosure.

For example, the system 900 may be used to assist in the performance of the methods described in FIGS. 3-7. For example, the system 900 may be used to for different processes of an exploratory offline generative online machine learning model.

Generally, the processor 910 may include any suitable special-purpose or general-purpose computer, computing entity, or processing device including various computer hardware or software modules and may be configured to execute instructions stored on any applicable computer-readable storage media. For example, the processor 910 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 9, it is understood that the processor 910 may include any number of processors distributed across any number of networks or physical locations that are configured to perform individually or collectively any number of operations described herein. In some embodiments, the processor 910 may interpret and/or execute program instructions and/or process data stored in the memory 912. In some embodiments, the processor 910 may execute the program instructions stored in the memory 912.

For example, in some embodiments, the processor 910 may execute program instructions stored in the memory 912 that are related to task execution such that the system 900 may perform or direct the performance of the operations associated therewith as directed by the instructions. In these and other embodiments, the instructions may be used to perform one or more blocks of methods 300, 400, 500, 600, and 700 of FIGS. 3-7.

The memory 912 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 910.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 910 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 916 may include any component, device, system, or combination thereof that is configured to transmit or receive information over a network. In some embodiments, the communication unit 916 may communicate with other devices at other locations, the same location, or even other components within the same system. For example, the communication unit 916 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 916 may permit data to be exchanged with a network and/or any other devices or systems described in the present disclosure.

The display 918 may be configured as one or more displays, like an LCD, LED, Braille terminal, or other type of display. The display 918 may be configured to present video, text captions, user interfaces, and other data as directed by the processor 910.

The user interface unit 920 may include any device to allow a user to interface with the system 900. For example, the user interface unit 920 may include a mouse, a track pad, a keyboard, buttons, camera, and/or a touchscreen, among other devices. The user interface unit 920 may receive input from a user and provide the input to the processor 910. In some embodiments, the user interface unit 920 and the display 918 may be combined.

Modifications, additions, or omissions may be made to the system 900 without departing from the scope of the present disclosure. For example, in some embodiments, the system 900 may include any number of other components that may not be explicitly illustrated or described. Further, depending on certain implementations, the system 900 may not include one or more of the components illustrated and described.

As indicated above, the embodiments described herein may include the use of a special purpose or general-purpose computer (e.g., the processor 910 of FIG. 9) including various computer hardware or software modules, as discussed in greater detail below. Further, as indicated above, embodiments described herein may be implemented using computer-readable media (e.g., the memory 912 of FIG. 9) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining a set of preliminary tabular datasets and tasks to be performed by preliminary machine-learning (ML) pipelines;
training a prediction model that predicts performance of ML pipelines in performing the tasks using the preliminary ML pipelines, the preliminary ML pipelines synthesized as different approaches for performing the tasks;
obtaining a candidate tabular dataset;
predicting, using the prediction model, performance of a plurality of candidate ML pipelines for performing the tasks on the candidate tabular dataset;
selecting a threshold number of top-performing candidates of the plurality of candidate ML pipelines as predicted by the prediction model for training to perform the task; and
identifying a top-performing ML pipeline based on performance of the trained top-performing candidates.

2. The method of claim 1, wherein training the prediction model comprises:
splitting the set of preliminary tabular datasets into a training subset and a validation subset;
training each of the preliminary ML pipelines with the training subset;
confirming performance of the preliminary ML pipelines with the validation subset;
recording the performance of the preliminary ML pipelines; and
training the prediction model using the performance of the preliminary ML pipelines and dataset meta-features of the set of preliminary tabular datasets and pipeline meta-features of the preliminary ML pipelines.

3. The method of claim 2, further comprising:
extracting the dataset meta-features from the set of preliminary tabular datasets, the dataset meta-features including characteristics of a given tabular dataset of the preliminary tabular datasets; and
extracting the pipeline meta-features from the preliminary ML pipelines, the pipeline meta-features including characteristics of a given ML pipeline of the preliminary ML pipelines.

4. The method of claim 3, wherein the characteristics of the given tabular dataset of the preliminary tabular datasets include one or more of a number of rows, a number of features, a presence of a number, a presence of missing values, a presence of a number category, a presence of a string category, a presence of text, a median, a mean, a mode, a distribution, a maximum value, a minimum value, and a label for categories of information.

5. The method of claim 3, wherein the characteristics of the given ML pipeline of the preliminary ML pipelines include a set of preprocessing components present in the given ML pipeline, one or more ML models included in the preliminary ML pipelines, or both.

6. The method of claim 2, wherein the recorded performance of each of the preliminary ML pipelines comprise one or more scores and an execution time.

7. The method of claim 3, wherein inputs to the prediction model include the dataset meta-features and the pipeline meta-features.

8. The method of claim 1, further comprising:
after obtaining the candidate tabular dataset:
extracting second dataset meta-features from the candidate tabular dataset;
obtaining the plurality of candidate ML pipelines;
extracting second pipeline meta-features from each of the plurality of candidate ML pipelines; and
combining the second pipeline meta-features and the second dataset meta-features.

9. The method of claim 1, wherein the top-performing candidates include the threshold number of the plurality of candidate ML pipelines selected based on an execution time of each of the plurality of candidate ML pipelines.

10. The method of claim 1, wherein the top-performing candidates include the threshold number of the plurality of candidate ML pipelines selected based on an execution time and performance score of each of the plurality of candidate ML pipelines.

11. The method of claim 1, wherein the prediction model is configured to adapt to variable sizes of the set of preliminary tabular datasets and the candidate tabular dataset.

12. The method of claim 11, wherein the adaptation to variable sizes includes:
generating dataset-level meta-features of the preliminary tabular datasets;
generating column-level meta-features of the preliminary tabular datasets; and
combining the dataset-level meta-features and the column-level meta-features of the preliminary tabular datasets.

13. The method of claim 8, further comprising:
after extracting the second dataset meta-features from the candidate tabular dataset:
obtaining a list of options for preprocessing components;
removing one or more of the options without related second dataset meta-features from the list; and
generating the plurality of candidate ML pipelines based on the list of options for preprocessing components.

14. The method of claim 1, further comprising:
training a failure model that predicts probability of ML pipelines of failing to perform the tasks using the preliminary ML pipelines;
predicting, using the failure model, probability of failure of the plurality of candidate ML pipelines in performing the tasks on the candidate tabular dataset; and
removing a number of the plurality of candidate ML pipelines with the probability of failure above a failure probability threshold.

15. A system comprising:
one or more processors; and
one or more non-transitory computer-readable storage media configured to store instructions that, in response to being executed, cause a system to perform operations, the operations comprising:
obtaining a set of preliminary tabular datasets and tasks to be performed by preliminary machine-learning (ML) pipelines;
training a prediction model that predicts performance of ML pipelines in performing the tasks using the preliminary ML pipelines, the preliminary ML pipelines synthesized as different approaches for performing the tasks;
obtaining a candidate tabular dataset;
predicting, using the prediction model, performance of a plurality of candidate ML pipelines for performing the tasks on the candidate tabular dataset;
selecting a threshold number of top-performing candidates of the plurality of candidate ML pipelines as predicted by the prediction model for training to perform the task; and
identifying a top-performing ML pipeline based on performance of the trained top-performing candidates.

16. The system of claim 15, wherein training the prediction model comprises:
splitting the set of preliminary tabular datasets into a training subset and a validation subset;
training each of the preliminary ML pipelines with the training subset;
confirming performance of the preliminary ML pipelines with the validation subset;
recording the performance of the preliminary ML pipelines; and
training the prediction model using the performance of the preliminary ML pipelines and dataset meta-features of the set of preliminary tabular datasets and pipeline meta-features of the preliminary ML pipelines.

17. The system of claim 16, further comprising:
extracting the dataset meta-features from the set of preliminary tabular datasets, the dataset meta-features including characteristics of a given tabular dataset of the preliminary tabular datasets; and
extracting the pipeline meta-features from the preliminary ML pipelines, the pipeline meta-features including characteristics of a given ML pipeline of the preliminary ML pipelines.

18. The system of claim 17, wherein the characteristics of the given tabular dataset of the preliminary tabular datasets include one or more of a number of rows, a number of features, a presence of a number, a presence of missing values, a presence of a number category, a presence of a string category, a presence of text, a median, a mean, a mode, a distribution, a maximum value, a minimum value, and a label for categories of information.

19. The system of claim 17, wherein the characteristics of the given ML pipeline of the preliminary ML pipelines include a set of preprocessing components present in the given ML pipeline, one or more ML models included in the preliminary ML pipelines, or both.

20. The system of claim 17, wherein inputs to the prediction model include the dataset meta-features and the pipeline meta-features.
